(19) United States
(12) Patent Application Publication
(10) Pub. No.: US 2013/0034648 A1
(43) Pub. Date: Feb. 7, 2013

(54) PARTIALLY FROZEN BEVERAGES INCLUDING BETAINE

(71) Applicants: Bharani K. Ashokan, McKinney, TX (US); Timothy J. Gross, Henderson, CO (US); Adrian M. Sepcic, Frisco, TX (US)

(72) Inventors: Bharani K. Ashokan, McKinney, TX (US); Timothy J. Gross, Henderson, CO (US); Adrian M. Sepcic, Frisco, TX (US)

(21) Appl. No.: 13/566,230

(22) Filed: Aug. 3, 2012

Related U.S. Application Data
(60) Provisional application No. 61/514,768, filed on Aug. 3, 2011.

(51) Int. Cl. A23L 2/60; A23L 2/39; A23L 2/385

(52) U.S. Cl. 426/548

(57) ABSTRACT

Reduced-calorie, partially-frozen mixes, concentrates, and beverage products may include betaine and may include a level of natural-caloric sweeteners that may be significantly reduced from that of a full-calorie, partially-frozen beverage. The mixes may be compatible with commercially available machinery for the production of partially-frozen beverages. Reduced-calorie, partially-frozen beverages may include up to about 4% by weight betaine, and may provide a mouthfeel and texture that is desirable, particularly for a beverage that includes solid particles.

### CROSS REFERENCE TO RELATED APPLICATIONS

This application claims the benefit of U.S. Provisional Patent Application No. 61/514,768 filed Aug. 3, 2011, the disclosure of which is herein wholly incorporated by reference.

### FIELD

This application generally relates to reduced-calorie, partially-frozen beverages as well as to concentrates or mixes used in their production. The reduced-calorie, partially-frozen beverage compositions described herein include betaine, one or more high intensity sweeteners, and may be reduced in concentration or substantially free of natural-caloric sweeteners.

### BACKGROUND

Diet or reduced-calorie products have reduced sugar content, and therefore a lowered contribution of sweetness afforded from caloric sugars. Such products may contain high-intensity sweeteners, non-nutritive sweeteners, nutritive-sweeteners, or combinations thereof to try to compensate for lost sweetness and improve overall taste. Unfortunately, according to many consumers, such sweeteners, individually or in combination, do not impart exactly the same taste as natural sugars, and such consumers may experience negative taste characteristics of consumable items that include those sweeteners. Negative attributes associated with such consumable items include but are not limited to a lack of upfront sweetness, lingering sweetness, and a lack of overall flavor. Additionally, the general mouthfeel of reduced-calorie consumable items may suffer in the absence of the syrup-like feel or texture that is associated with sugars. Deficiencies in sweetness and consumable item texture may also influence aftertaste and off-taste characteristics that may be associated with high-potency sweeteners. In beverages, attempts to overcome such concerns have been only partially successful.

Frozen or partially-frozen food products, such as slush-type and frozen-carbonated beverages, commonly have high levels of sweetness, and attempts to configure low-calorie versions of the products are complicated by additional factors. In partially-frozen food products, sugars not only provide sweetness and mouthfeel, but they also provide a solute concentration that stabilizes ice crystals, and such stabilization may be important in the overall texture of the product during consumption. In addition, for partially-frozen beverage mixes, sugars serve to both lower the freezing point of the mix and also help control the consistency of the forming product, which are roles that influence whether such mixes may be compatible with conventional machinery designed for their manufacture, which typically operate at temperatures that are several degrees below the freezing point of pure water and are designed to operate with compositions of a given consistency. Without proper control of the freezing point and phase transformation kinetics, a mix in the process of phase change may, for example, experience rapid and uncontrolled freezing, and in some cases large ice clusters may adhere to elements of production machinery—potentially damaging the production machinery. Furthermore, the freezing characteristics of a mix may impact the relative distribution and size of ice particles in the produced partially-frozen beverage, and such may, for example, affect various attributes of the beverage including, among other attributes, mouthfeel, flavor, sweetness, and overall texture. Thus, reduced-calorie, partially-frozen food products have additional production constraints, in addition to other concerns in wholly liquid beverage systems.

Therefore, the creation of reduced-calorie, partially-frozen food products is complicated because such products may provide an inadequate solute concentration to sufficiently depress freezing point, control the phase change of a composition, and stabilize ice crystals. Previous attempts to produce reduced-calorie, partially-frozen food products have not properly compensated for loss of solute density upon the reduction of sugar levels and have not adequately met the aforementioned concerns. In addition, some attempts to produce reduced-calorie, partially-frozen food products have involved the providing of relatively high amounts of sugar alcohols or using other components that for a segment of consumers may not be well tolerated. In light of the foregoing, it would be beneficial to provide diet or reduced-calorie food and beverage mixes capable of undergoing controlled phase transitions that have desirable taste characteristics and that are well tolerated for consumers.

### SUMMARY

In some embodiments, reduced-calorie, partially-frozen compositions, such as mixes and beverages produced therefrom, may include betaine. Betaine may be added to partially-frozen compositions in percentages between about 0.1% to about 4% by weight. The compositions may include betaine and a level of natural-caloric sweeteners that is reduced as compared to typical levels in full-calorie versions of partially-frozen beverages. In some embodiments, the amount of natural-caloric sweeteners may be significantly reduced or absent from a partially-frozen beverage.

### BRIEF DESCRIPTION OF THE DRAWINGS

FIG. 1 is a graph showing the freezing characteristics of various compositions.

FIG. 2 is a graph showing the freezing characteristics of two duplicate solutions of 14.5° Bx HFCS 55.

FIG. 3 is a graph showing the freezing characteristics of two duplicate solutions of 10.8° Bx HFCS 55 and 0.5% by weight betaine.

FIG. 4 is a graph showing the freezing characteristics of two duplicate solutions of 10.8° Bx HFCS 55 and 10.0% by weight betaine.

FIG. 5 is a graph showing an increase in particle density (in millimoles of solute per kilogram of solvent water) upon addition of different components vs. the component's weight percent.

### DETAILED DESCRIPTION

The following terms as used herein should be understood to have the indicated meanings.

When an item is introduced by “a” or “an,” it should be understood to mean one or more of that item.

“Comprises” means includes but is not limited to.

“Comprising” means including but not limited to.

“Having” means including but not limited to.

The term “beverage” as used herein means any drinkable liquid or semi-liquid, including for example flavored water, soft drinks, fruit drinks, coffee-based drinks, tea-based drinks, juice-based drinks, milk-based drinks, gel drinks, carbonated or non-carbonated drinks, alcoholic or non-alcoholic drinks.

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “high-potency sweetener” means any ingredient that initiates a perception of sweetness at a concentration less than that which would be required for a natural-caloric sweetener. High-potency sweeteners may include by way of nonlimiting example acesulfame-K, aspartame, saccharin, stevia, sucralose, and a combination of any of the foregoing.

The term “natural-caloric sweetener” refers to any of various naturally occurring sugars that provide greater than about 3.5 kilocalories of energy per gram. Natural caloric sugars may include by way of nonlimiting example fructose, glucose, sucrose, and a combination of any of the foregoing.

The term “non-nutritive sweetener” refers to any of various materials that initiate a perception of sweetness but are substantially free of caloric content. Non-nutritive sweeteners provide less than 0.5 kilocalories per gram. Non-nutritive sweeteners may include by way of nonlimiting example erythritol, aspartame, saccharin, sucralose, and a combination of any of the foregoing.

The term “nutritive sweetener” refers to any of various materials that initiates a perception of sweetness and provides less than about 3.2 kilocalories per gram but greater caloric content than a non-nutritive sweetener. Nutritive sweeteners may include by way of nonlimiting example tagatose, sorbitol, mannitol, malitol, isomalt, lacitol, and a combination of any of the foregoing.

The term “partially-frozen” means a material that includes a proportion of ice crystals. Some food products that may be consumed in a partially-frozen state may include but are not limited to food products commonly referred to as “frozen-carbonated beverages,” “smoothies,” and “slush” products.

The term “intensity of a sweetener” means the rate of change of sweetness level as the concentration of the sweetener is changed.

“Flavor potentiator” means a material that can intensify, supplement, modify or enhance the taste and/or aroma perception of a composition without introducing a characteristic taste and/or aroma perception of its own. Flavor potentiators may supplement, modify, or enhance the perception of flavor, sweetness, tartness, umami, kokumi, saltiness, bitterness, and a combination comprising any of the foregoing, for example.

This disclosure is directed to reduced-calorie, partially-frozen foods and beverages that include the soluble solute betaine. In addition, this disclosure describes mixes that may be used to create reduced-calorie, partially-frozen beverages. A mix, which in some embodiments may be a syrup, may be configured such that, without significant dilution, the mix may be cooled to initiate partial freezing, and a reduced-calorie, partially-frozen beverage may be formed in an apparatus configured for production of a partially-frozen beverage. Alternatively, a mix may be distributed in the form of a concentrate. A concentrate may be appropriately diluted, such as with water or other ingredients, at a time following the distribution of the concentrate to a location where a reduced-calorie, partially-frozen beverage may be formed. In general, in this disclosure, where reference is made to a mix that may be added to an apparatus for production of a partially-frozen beverage or where description of a reduced-calorie, partially-frozen beverage is made, a concentrate, capable of forming the mix or product beverage by appropriate dilution, combination, or processing, is also envisioned.

In some embodiments, a mix for use in making a reduced-calorie, partially-frozen, beverage may include betaine and one or more natural-caloric sweeteners that are reduced in concentration as compared to a full-calorie version of a product beverage. For example, in some embodiments, a reduced-calorie, partially-frozen beverage may be produced from a reduced-calorie mix that includes betaine and natural-caloric sweeteners at a level that is between about 25% to about 85% in comparison to the amount of natural-caloric sweeteners in a full-calorie, partially-frozen beverage mix. By way of nonlimiting example, within that range, a reduced-calorie, partially-frozen beverage mix may include a level of natural sweeteners that is reduced to a level that is about 25% to about 45%, or about 40% to about 60%, or about 55% to about 85%, as compared to the level of natural-caloric sweeteners in a typical full-calorie, partially-frozen beverage mix.

For reference, a full-calorie, partially-frozen beverage mix may typically include a brix level of carbohydrate sugars of between about 12° Bx to about 14.5° Bx. However, some partially-frozen beverages, such as those beverages including certain flavors, may include even greater levels of carbohydrate sugars. By way of nonlimiting example, carbohydrate sugars included in partially-frozen mixes and partially-frozen beverages may include any of various monosaccharides, disaccharides, sucrose, fructose, glucose, sucrose, isomerized sugars such as high fructose corn syrup (e.g., HFCS55, HFCS42, or HFCS90), or other carbohydrate sugars. In some embodiments, a mix may include a foaming agent, such as yucca schidigera extracts, quillaia extracts, one or more other foaming agents, or mixtures thereof. For example, some varieties of frozen-carbonated beverages (FCB) may typically include one or more foaming agents. A mix including a foaming agent may be configured to provide a substantial volume over-run, such as about 80% to about 120% or some other percentage, upon production of a partially-frozen beverage. For example, with a volume over-run of about 100%, a given ounce of a mix may result in the production of about 2 ounces of a partially-frozen beverage product. In some embodiments, the density of a reduced-calorie, partially-frozen beverage may be lower than in the corresponding mix from which it was produced; however, the relative proportion of ingredients, such as expressed in terms of a weight percent, may be comparable or only slightly different. However, the calorie content of a given ounce of a low-density beverage product may be decreased by including a foaming agent and/or a foaming agent in combination with carbonation in comparison with product versions that do not include a foaming agent.

Betaine, which may also be referred to as trimethylglycine, and which should not be confused with the more general class of all alkyl betaine surfactants, may be included in a reduced-calorie, partially-frozen beverage mix at up to about 4.0% by weight. In some embodiments, betaine may be included in a reduced-calorie, partially-frozen beverage mix at a weight percent of about 0.1% to about 0.5%, or about 0.4% to about 1.0%, or about 0.8 to about 1.5%, or about 1.4% to about 2.0%, or about 1.8% to about 2.5%, or about 2.2% to about 3.0%, or about 2.8% to about 4.0%.

In some embodiments, betaine may be included in a reduced-calorie, partially-frozen, beverage mix at molal levels of up to about 0.35 moles per kilogram of mix solvent, such as water. Natural-caloric sweeteners may, therefore, be reduced from typical levels in a full-calorie product by as much as 75%, and one or more high-potency sweeteners may be added to offset the reduction in sweetness due to the reduction of natural-caloric sweeteners. In some embodiments, other ingredients in such beverages (i.e., ingredients except for sweeteners and betaine), such as buffering components, salts, foaming agents, flavorants, and other ingredients, if present, may be present in similar molal concentrations as found in a full-calorie version of the product. Betaine may therefore be conveniently added to a mix at significant levels, affording a substantial freezing point depression, and facilitating the production of reduced-calorie product versions. In some embodiments, betaine may be included in a reduced-calorie mix which has similar consistency and/or viscosity to that of a full-calorie mix, and the reduced-calorie mix may be fully compatible with commercially available apparatuses for production of partially-frozen beverages. Betaine, may, in some embodiments, provide a characteristic texture and mouthfeel upon consumption. Moreover, when solid particles, such as ice crystals, are present along with liquid portions of a partially-frozen beverage including betaine, the composition may provide a texture and mouthfeel that some consumers find to be desirable.

Substitution in a mix of a mass of natural-caloric sweetener with a given mass of betaine may result in a lowered freezing point for that mix. For example, a mass of betaine contains approximately 3 times the number of particles as does the same mass of sucrose sugar. Betaine may therefore be used at relatively low mass levels, without addition of substantial caloric content, yet still provide sufficient freezing point depression, and may be configured in reduced-calorie, partially-frozen mixes and beverages. For example, including betaine as a component in a mix contributes to the solute particle density of the mix, thereby suppressing the freezing point of the mix, such as to a suitable level that may be compatible with commercial production machinery. Betaine may contribute solute density in a reduced-calorie mix, and may do so without significant disruption of desirable properties of the mix, and providing much less caloric contribution than would sugars at a solute level to provide the same freezing depression. The calorie content of reduced-calorie, partially frozen beverages including betaine may thus be significantly lowered. Such products may, upon consumption, provide as low as about 4 kilocalories of energy per ounce, and furthermore may provide a characteristic mouthfeel and texture that may be desirable.

In some embodiments, reduced-calorie, partially-frozen beverages may be produced without including sugar alcohols or only including sugar alcohols at low levels. That is, sugar alcohols may, in some embodiments, be used to replace a limited amount of natural-caloric sweeteners in partially-frozen beverages. However, sugar alcohols, at some concentrations, have been found to provide undesirable gastrointestinal effects. For example, sugar alcohols are incompletely absorbed in the small bowel and have been implicated to cause flatulence and even diarrhea, at least in some individuals. Sugar alcohols, included in some embodiments of reduced-calorie, partially-frozen beverages described herein, may, by way of nonlimiting example, include erythritol, sorbitol, mannitol, maltitol, xylitol, other food-grade sugar alcohols, or combinations thereof. Erythritol provides minimal caloric contribution upon consumption and may, in some embodiments, be included in an amount that does not exceed about 2.5% by weight in a reduced-calorie, partially-frozen mix or beverage. A sugar alcohol may, in some embodiments, be included in a reduced-calorie, partially-frozen beverage or mix in weight percent of about 0.1% to about 0.25%, or about 0.20% to about 0.5%, or about 0.4% to about 0.8%, or about 0.6% to about 1.0%, or about 0.8% to about 1.5%, or about 1.5% to about 2.0%, or about 1.8% to about 2.5%.

In addition, in some embodiments, reduced-calorie, partially-frozen beverages may substantially avoid the use of low-digestible carbohydrate sweeteners (such as inulin, trehalose, and D-tagatose), that are only slowly absorbed in the small bowel or that are not absorbed substantially completely in the small bowel and which, particularly when used in combination with sugar alcohols, may contribute to gastrointestinal discomfort in some consumers upon consumption of a partially-frozen beverage. For example, in some embodiments, a reduced-calorie, partially-frozen beverage mix or beverage may include no more than about 2.5 weight percent, no more than about 2 weight percent, no more than about 1.5 weight percent, or no more than about 1.0 weight percent total of sugar alcohols and low-digestible carbohydrate sweeteners for which small bowel absorption is inefficient. Some of those embodiments may include betaine, less than about 6 weight percent natural-caloric sweeteners and provide as few as about 4 kilocalories of energy per ounce of product. In some embodiments, a reduced-calorie, partially-frozen beverage may include a total molal composition of sugar alcohols and/or low-digestible carbohydrate sweetening components of less than about 0.20 moles per kilogram of mix water, or less than 0.17 moles per kilogram of mix water, or less than 0.12 moles per kilogram of mix water, or less than 0.10 moles per kilogram of mix water.

In some embodiments, a beverage component useful for substitution of natural sweeteners in a reduced-calorie, partially-frozen beverage should provide low caloric content, not adversely affect taste or other attributes of the beverage (for example, the solute should be substantially free of significant aftertastes), contribute to the overall mouthfeel and texture of the product, facilitate the formation and stabilization of small and uniform ice particles, and be compatible with conventional machinery for production of partially-frozen beverages. When incorporated in a mix for production of partially-frozen beverages, betaine may meet the aforementioned results, and in some embodiments may be ideally suited for substitution of at least a portion of natural sweeteners. The presence of betaine may be particularly suited to prevent the formation of larger ice clusters which have previously been found to be present in some reduced-calorie, partially frozen beverages. The presence of large ice clusters is undesirable not only because such may adversely affect the texture of a resulting partially-frozen beverage, but also because larger ice crystals have been found to interfere with the operation of machinery for production of partially-frozen beverages. For example, large ice crystals may become attached and rotate with impellars of the production machinery. Betaine, which is an effective de-icing agent, may be particularly well suited to inhibit and/or remove ice crystals from components of production machinery.

In addition, the make-up of a mix, including the identity and concentration of dissolved solute components, may, upon cooling the mix, impact the temperature at which the composition changes phase, the rate at which a phase transformation occurs, and the stability and size distribution of ice particles that may be present in the resulting partially-frozen beverage. Natural-caloric sweeteners, present in full-calorie partially-frozen beverage mixes, typically assist in stabilizing small ice particles, and without those sweeteners ice particles that form upon cooling may be too large or unacceptably inhomogeneous. Particle size and the nature of the phase transformation may impact various properties that influence consumer acceptance of the partially-frozen beverage, including, by way of non-limiting example, the partially-frozen beverage's texture, mouthfeel, sweetness, other properties of the product and changes in the product that occur during consumption, e.g., as a partially-frozen beverage melts. Including betaine may provide a beverage that not only provides a desired taste and consistency upon dispensing the product, but also provides a desired taste and consistency over time, such as while the product melts.

As previously noted, the reduced-calorie, partially-frozen beverages described herein may, in some embodiments, include betaine and natural-caloric sweeteners at a level that is between about 25% to about 85% in comparison to a level of natural-caloric sweeteners in a full-calorie, partially-frozen beverage mix. For example, a brix level of natural-caloric sweeteners may be about 3° Bx to about 6° Bx, or about 4.8° Bx to about 7.2° Bx, or about 6.5° Bx to about 10.2° Bx. In further example, a brix level of natural-caloric sweeteners may be about 2° Bx to about 7° Bx, or about 7° Bx to about 11° Bx. Some of those embodiments may include reduced-calorie, partially-frozen beverages wherein other ingredients, such as buffering components, salts, foaming agents, flavorants, and other ingredients, if present, may be included at comparable molal levels as found in full-calorie versions of the product. In some embodiments, such as those that include a combination of betaine and at least some sugar alcohol, natural-caloric sweeteners may be reduced even further, and may, for example, be absent from a reduced-calorie, partially-frozen beverage. In addition, other embodiments of reduced-calorie, partially-frozen beverages may include a combination of betaine and other ingredients that provide solute density and/or otherwise modify the freezing point of a beverage mix. For example, in some embodiments, the presence of betaine may be used with high concentrations of buffering salts, microcrystalline cellulose, surfactants, or other components that contribute to a lowering of the freezing point of a mix. In some of those embodiments, reduced-calorie, partially-frozen beverages may be substantially free of natural-caloric sweeteners.

Reduced-calorie, partially-frozen beverages may include betaine and one or more sweeteners. Sweeteners used in some embodiments may include high-potency sweeteners, natural-caloric sweeteners, nutritive-sweeteners, and combinations thereof. In some embodiments, a partially-frozen, reduced-calorie beverage may include betaine and a combination of sweeteners selected from the group of sucralose, acesulfame-potassium, and one or more sugar alcohols, such as erythritol. Sucralose and acesulfame-potassium are high-intensity sweeteners that are much sweeter than natural-caloric sweeteners. In some embodiments, sucralose may be present in a reduced-calorie, partially frozen beverage at between about 10 ppm and about 300 ppm, or between about 50 ppm and about 200 ppm. Acesulfame-potassium may, in some embodiments, be present in a product reduced-calorie, partially frozen beverage at between about 10 ppm and about 100 ppm, or between about 50 ppm and about 80 ppm.

Natural-caloric sweeteners may, in some embodiments, be included at concentrations that by themselves are insufficient to achieve an acceptable level of sweetness, for example, a level of sweetness typical of full-calorie, partially-frozen beverages. High-potency sweeteners used may, in some embodiments, also be included at concentrations that by themselves are insufficient to achieve an acceptable level of sweetness. A combination of high-potency sweeteners and one or more natural-caloric sweeteners may, however, be sufficient to provide adequate sweetness in a reduced-calorie, partially-frozen beverage. In some embodiments, the overall sweetness level provided by the sweeteners may be greater than would be expected by simply adding the combination of high potency sweeteners and the one or more natural sweeteners. In those embodiments, the combination of sweeteners may provide non-linearity in the overall sweetness level that is perceived.

Without being limited to a particular sweetener, representative categories and examples include:

(a) water-soluble sweetening agents such as dihydrochalcones, monellin, steviosides, glycyrrhizin, dihydroflavenol, dihydroflavonol, and sugar alcohols such as sorbitol, mannitol, maltitol, and L-aminodicarboxylic acid aminoalkenoic acid ester amides, such as those disclosed in U.S. Pat. No. 4,619,834 of Zanno et al., and mixtures thereof,

(b) water-soluble artificial sweeteners such as soluble saccharin salts, e.g., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof,

(c) dipeptide based sweeteners, such as L-aspartic acid derived sweeteners, such as L-aspartyl-L-phenylalanine methyl ester (Aspartame) and materials described in U.S. Pat. No. 3,492,131 of Schlatter, L-alpha-aspartyl-N-(2,2,4,4-tetramethyl-3-thietanyl)-D-alaninamide hydrate (Alitame), N—[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof,

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-1-fructrofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-1-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideo-x y-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein-based sweeteners such as thaumaoccous danielli (Thaumatin I and II); and

(f) the naturally occurring sweetener monatin (2-hydroxy-2-(indol-3-ylmethyl)-4-aminoglutaric acid) and its derivatives.

In some embodiments, a partially-frozen, reduced-calorie beverage may include betaine, one or more sweeteners, and one or more flavor potentiators. In some embodiments, betaine may be a component that, in addition to providing a solute concentration to depress the freezing point of a beverage, may, act as a flavor potentiator. Sweetener potentiators, which are a type of flavor potentiator, may enhance the taste of sweetness.

In some embodiments, exemplary sweetener potentiators may include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), and a combination comprising any of the foregoing potentiators. In some embodiments, the combination of sweeteners and one or more taste potentiators may provide non-linearity in the overall sweetness level that is perceived.

Reduced-calorie, partially-frozen beverages described in this disclosure, may, in some embodiments, have a similar taste to full-calorie beverages. The taste characteristics of reduced-calorie, partially-frozen beverages may, in some embodiments, be similar to full-calorie beverages because of the suppression of at least one negative characteristic commonly associated with other beverages designed with lower calorie content than full-calorie consumables. By way of non-limiting example, some negative characteristics commonly associated with other lower calorie content beverages may include inadequate overall sweetness, excessive overall sweetness, lacking upfront sweetness, lingering sweetness, lacking overall flavor, a sweetness that reduces with repetitive tasting, having limited or improper mouthfeel, having off-taste properties such as bitter, metallic or licorice-like aftertaste, and combinations of the foregoing.

Some of the aforementioned characteristics of consumables may be related to the temperature at which they are consumed. Furthermore, partially-frozen beverages may be chewed and sucked on during consumption. Those beverages may be held in the mouth for a significantly longer period of time than non-frozen beverages. Therefore, the consumption of some partially-frozen beverages and the simulation of oral receptors, including for example sweetness receptors, may be more persistent than for non-frozen beverages. Persistent stimulation of receptors may impact the aforementioned negative characteristics of reduced calorie sweeteners in various ways. For example, in some embodiments partially-frozen beverages may include sweetener systems designed to minimize off-taste characteristics, excessive sweetness, or the reduction of sweetness with repetitive tasting.

Sweeteners included in a reduced-calorie, partially-frozen beverage may influence the above mentioned negative characteristics of other diet beverages in various ways. Sweeteners included in a partially-frozen consumable item may be used in controlled amounts and proportions in order to optimize the taste characteristics of a partially-frozen beverage. The influence of sweeteners on negative characteristics may be directly attributed to stimulation of sweetness receptors in the oral cavity, such as is the case, for example, in inadequate overall sweetness or lacking upfront sweetness, or may be related to the sweeteners indirectly, such as may be the case for negative characteristics including, for example, improper mouthfeel, lacking overall flavor, or having off-taste properties. In general, the sweetness properties associated with natural sugars are most appealing, and attempts may be made in some embodiments of reduced-calorie consumable items to match the properties of natural sugars. A description of the properties of natural sugar or of a sweetener in general may include the sweetness level which characterizes the magnitude in which a consumer perceives the property of sweetness. A description of a sweetener may also include how the perception of sweetness varies as a function of time, including sweetness perception immediately after sampling a consumable item and at other time points following consumption. A description of a sweetener may also include the level of sweetness perceived for the entire oral cavity or with different values in individual regions of the oral cavity, such as regions of the oral cavity where an individual may chew on ice particles. In addition to providing adequate levels of the perception of sweetness, sweetener combinations described herein may be made that match the time dependence of natural sugars, the spatial dependence of natural sugars, or both. In some embodiments, sweeteners that match the sweetness level, time dependence, or spatial dependence of natural sugar, at the concentration of a full-calorie, partially-frozen consumable item, may suppress negative characteristics commonly associated with consumable items of lower calorie content.

When used at concentrations commonly found in full-calorie, partially-frozen beverages, natural sugars may provide a high level of sweetness. In this respect, one may differentiate the level of sweetness that may be achieved with a sweetener from the intensity of the sweetener. In comparison to natural sugars, some high-potency sweeteners may show a more rapid increase in sweetness with increasing concentration in ranges where the sweetener is used in relatively low amounts. This behavior may not hold at higher concentrations, and the maximum sweetness level that may be achieved with high-potency sweeteners may not be as high as that of natural sugar. In some embodiments, a combination of sweeteners may be used in a partially-frozen, reduced-calorie consumable item that provides a level of sweetness comparable to that of a full-calorie, partially-frozen consumable item but providing significantly lower calorie content.

In some embodiments, a partially-frozen, reduced-calorie beverage may be a carbonated beverage, and may include a combination of one or more sweeteners, and betaine. Betaine may in some embodiments serve to facilitate phase change during freezing and stabilize carbon dioxide during production of a partially-frozen, reduced-calorie carbonated beverage. In some embodiments of partially-frozen, reduced-calorie carbonated beverages, betaine may be used with some amount of one or more sugar alcohols. In some embodiments, a reduced-calorie, partially-frozen, beverage may be a carbonated beverage, and may include betaine, and a sweetener system consisting of one or more high-potency sweeteners and erythritol. In some embodiments, including but not limited to carbonated products, betaine may be used with one or more sweeteners to provide a reduced-calorie, partially-frozen beverage without addition of any nutritive sweetener.

In some embodiments, a partially-frozen, reduced-calorie beverage may include the addition of some alcohol. For example, a partially-frozen, reduced-calorie beverage may include between about 1% to about 20% ethyl alcohol by weight. In some embodiments, a partially-frozen, reduced-calorie beverage may include an extract from coffee or one or more coffee flavors.

In some embodiments, a consumable composition may include additives such as caffeine, coloring agents (“colorants”, “colorings”), emulsifiers, food-grade acids, minerals, micronutrients, plant extracts, preservatives, salts including buffering salts, stabilizers, thickening agents, medicaments, and a combination comprising any of the foregoing. Those of ordinary skill in the art will understand that certain additives may meet the definition or function according to more than one of the above-listed additive categories.

Exemplary salts may include alkali or alkaline earth metal chlorides, glutamates, and the like. For example, monosodium glutamate, potassium chloride, sodium chloride, and a combination comprising any of the foregoing salts may be used. The salts may be added to the partially-frozen beverage as a flavor potentiator as described above. Food-grade acids for use in certain embodiments of the consumable composition may include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising any of the foregoing food-grade acids. The food-grade acid may be added as acidulant to control the pH of the consumable composition and also to provide some preservative properties; or to stabilize the consumable composition. The pH of a partially-frozen beverage, syrup or mix, or concentrate may also be modified by the addition of food-grade compounds such as ammonium hydroxide, sodium carbonate, potassium carbonate, sodium bicarbonate, and the like, and a combination comprising any of the foregoing. Additionally, the pH may be adjusted by the addition of carbon dioxide. The pH may also affect the relative partition of solutes between liquid and solid portions of a beverage; such is particularly true if the pH is changed over a region where a solute becomes at least fractionally ionized. In some embodiments, the ionization of a component may be modified by selection of a pH that alters the fraction of a component which is ionized. In addition, a sweetener or bulk solute may in some cases be selected because within a desired pH range for a partially-frozen beverage, the component may exist in an ionized form.

A person having ordinary skill in the art will understand that embodiments of partially-frozen beverages may contain one or more flavors. Exemplary flavor oils may include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents may include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent may include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents may include aldehydes and esters such as cinnamyl acetate, cinnamaldehyde, citral diethylacetal, dihydrocarvyl acetate, eugenyl formate, p-methylamisol, and so forth. Examples of aldehyde flavorings may include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

The flavoring agents may be used in liquid or solid/dried form and may be used individually or in a mixture. When employed in dried form, suitable drying means such as spray drying an oil may be used. Alternatively, the flavoring agent may be absorbed onto water-soluble materials, such as cellulose, starch, sugar, maltodextrin, gum arabic and so forth or may be encapsulated. In still other embodiments, the flavoring agent may be adsorbed onto silicas, zeolites, and the like. The techniques for preparing such dried forms are well-known.

In some embodiments, the flavoring agents may be used in many distinct physical forms. Without being limited thereto, such physical forms may include free forms, such as spray dried, powdered, beaded forms, encapsulated forms, emulsions such as caramel or gum arabic emulsions, and a combination comprising at least one of the foregoing physical forms. The particular amount of the flavoring agent effective for imparting flavor characteristics to the composition may depend upon several factors including the flavor, the flavor impression, and the like.

In some embodiments, the tartness of a beverage may be varied by selecting and combining acids to provide a desired tartness perception. Some factors to consider in determining a desired tartness include, for example, the acid's dissociation constant, solubility, pH, etc. These variables may be measured by measuring the titratable acidity of a partially-frozen beverage, syrup or mix, or concentrate.

In some embodiments, a coloring agent may be used in amounts effective to produce a desired color for the composition. Exemplary coloring agents may include pigments, natural food colors and dyes suitable for food, drug and cosmetic applications. A full recitation of all colorants approved by the United States Food and Drug Administration, together with corresponding chemical structures, may be found in the Kirk-Othmer Encyclopedia of Chemical Technology, 3rd Edition, in volume 5 at pages 857-884, which text is incorporated herein by reference.

As classified by the United States Food, Drug, and Cosmetic Act (21 C.F.R. 73), colors may include those exempt from certification colors (sometimes referred to as natural even though they can be synthetically manufactured) and certified colors (sometimes referred to as artificial), and a combination comprising any of the foregoing. In some embodiments, exemplary colors exempt from certification or natural colors may include, for example, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising any of the foregoing.

In some embodiments, exemplary certified colors may include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising any of the foregoing. In some embodiments, certified colors may include FD&C aluminum lakes, which consist of the aluminum salts of FD&C dyes extended on an insoluble substrate of alumina hydrate. Additionally, in some embodiments, certified colors may be included as calcium salts.

In some embodiments, a consumable composition may include additional preservatives to provide freshness and to prevent the unwanted growth of bacteria, molds, fungi, or yeast. The addition of a preservative, including antioxidants, may also be used to maintain the composition's color, flavor, or texture. Exemplary preservatives may include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising any of the foregoing preservatives.

Syrups or mixes may be liquid or may be in the form of a powder or other solid. A syrup or mix may be in the form of a concentrate, and may be distributed with a water content that is lower than intended for a diluted composition created from the mix or syrup and which is intended to be placed in an apparatus capable of producing a frozen or partially frozen beverage. Syrups or mixes may be diluted prior to use and may be shipped in one or more portions that contain the same or different compositions. In general, in this disclosure where reference is made to a reduced-calorie, partially-frozen beverage, a concentrate, syrup or mix, capable of forming that reduced-calorie, partially-frozen beverage, such as, for example, by appropriate dilution or combination, is also envisioned.

The examples which follow are intended as illustrations of embodiments of the compositions described herein. It is understood that those compositions are described in an exemplary manner only.

### Example 1

In a first example, solutions of various ingredients were made and the freezing characteristics of those ingredients characterized. To characterize the freezing characteristics of the solutions, the ingredients were prepared or mixed and a temperature probe was placed in the solution such that it was completely immersed. A plastic beaker with the solution and probe was left in an environmental chamber held at 0° F. for 36 hours. The recorded temperatures were downloaded from the probe and plotted against time. The solutions tested in Example 1 include duplicate samples of water, duplicate samples of 14.5° Bx HFCS 55, duplicate samples of 10.8° Bx HFCS 55, duplicate samples of solutions including 10.8° Bx HFCS 55 and 0.5% by weight betaine, and duplicate samples of solutions including 10.8° Bx HFCS 55 and 10.0% by weight betaine.

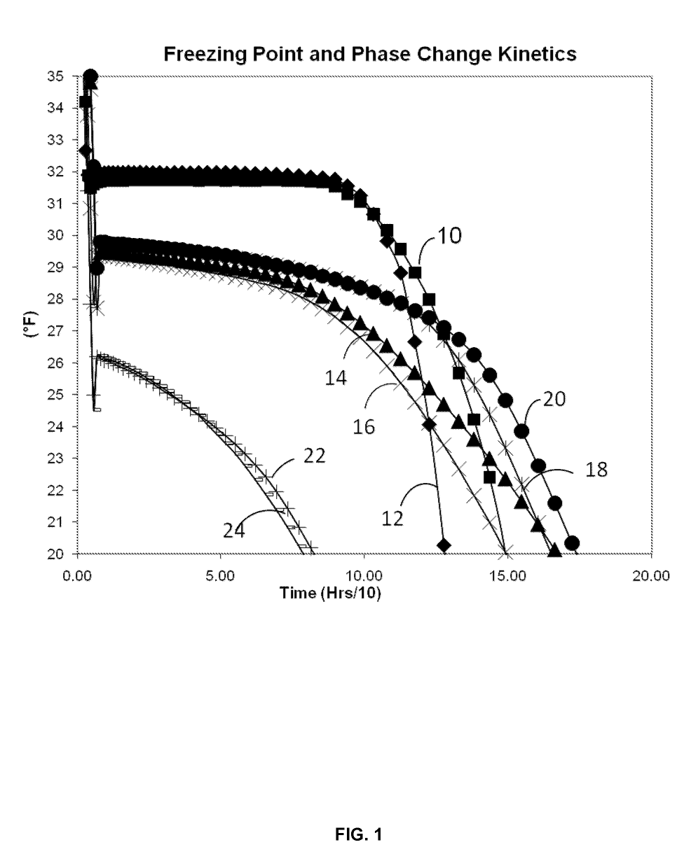

FIG. 1 is a graph showing the freezing characteristics of the various solutions tested in Example 1. The first inflection point may be taken as indicative that the solution has started to freeze. However, the data curves shown in FIG. 1 may be treated in various ways, for example, the slope and magnitude at any given data point of a curve may be calculated. Statistical analysis of the curves may then be performed and different modeling procedures associated with phase transition curves may be implemented to gather information about the solutions. For the solutions in FIG. 1, the time delay between different points on the curves, the slope of each curve at different time points, and the temperature at which each curve reaches inflection may be used to monitor the kinetics of phase transformation. In FIG. 1, two duplicate plots of temperature vs. time for water solutions are shown and indicated by labels 10 and 12, two duplicate plots of temperature vs. time for 14.5° Bx solutions of HFCS 55 are shown and indicated by labels 14 and 16, two duplicate plots of temperature vs. time for 10.8° Bx solutions of HFCS 55 and 0.5% by weight betaine are shown and indicated by the labels 18 and 20, and two duplicate plots of temperature vs. time for 10.8° Bx solutions of HFCS 55 and 10.0% by weight betaine are shown and indicated by labels 22 and 24.

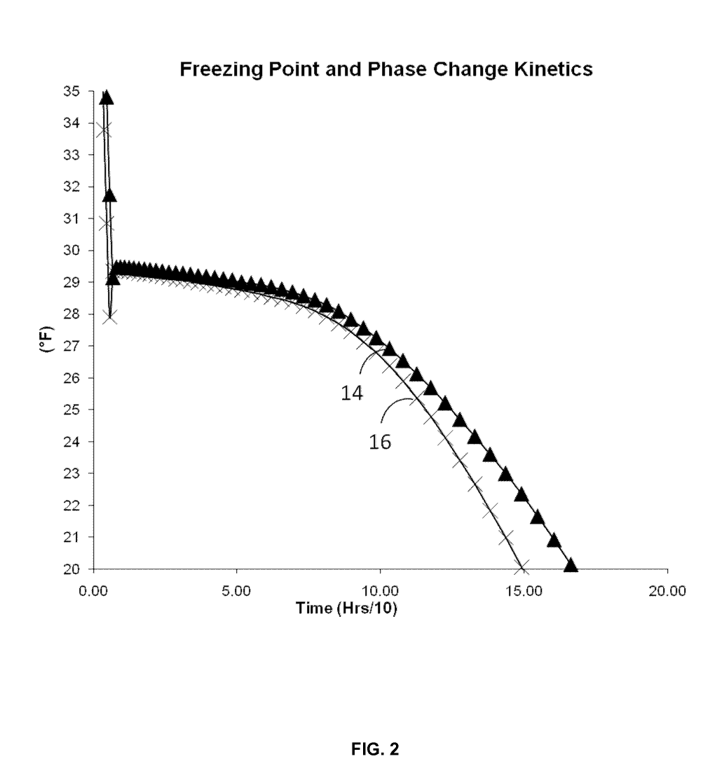

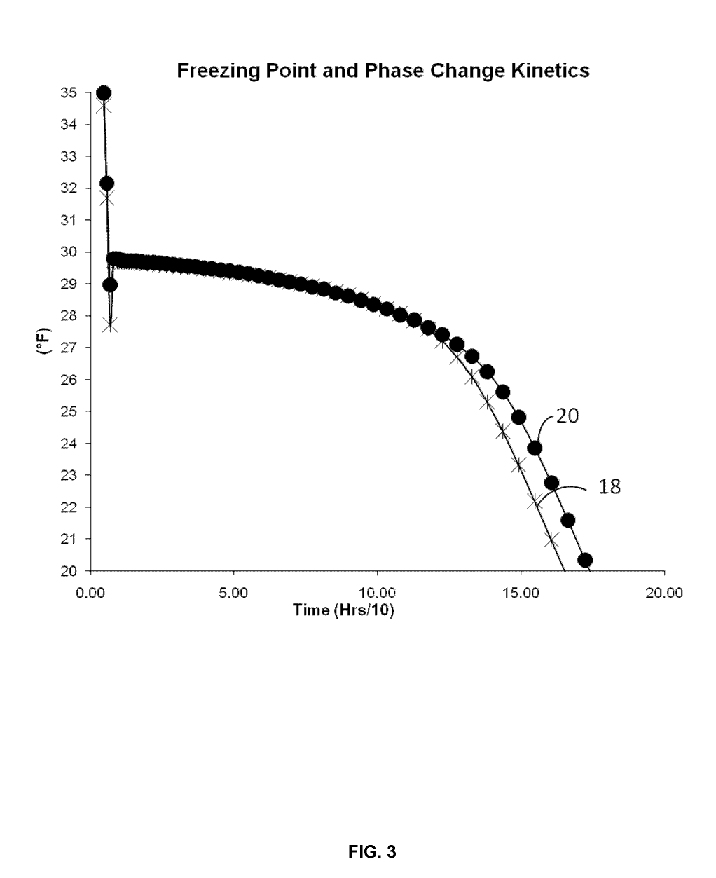

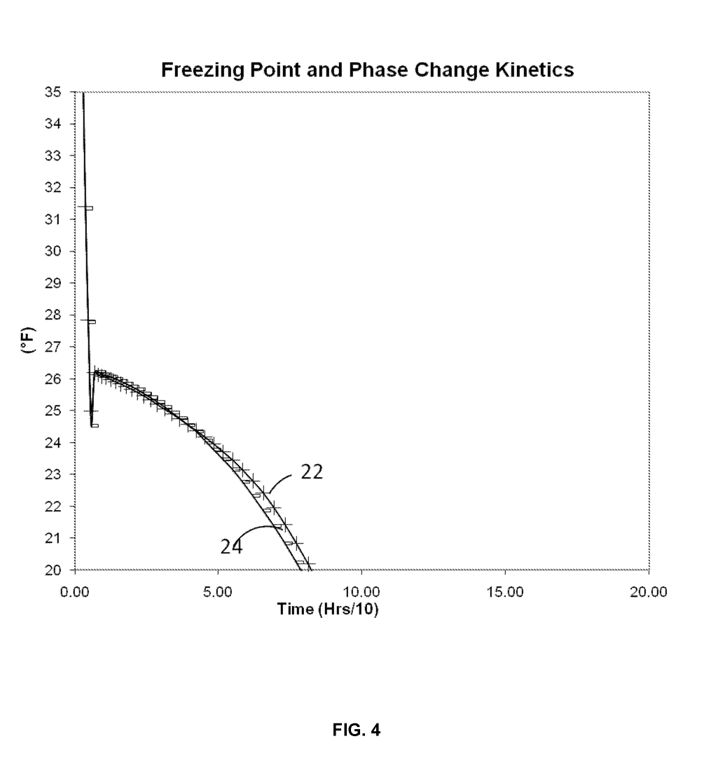

From the same experimental data used in FIG. 1, the curves 14 and 16 are shown without other curves in FIG. 2. Likewise, the curves 18 and 20 are shown without other curves in FIG. 3, and the curves 22 and 24 are shown without other curves in FIG. 4.

### Example 2

In this Example 2, the osmolality of various samples was determined using a commercially-available, freezing-point-depression osmometer, model Osmette II Model 5005, available from Precision Systems Inc. (Natick, Ma). The instrument was calibrated prior to testing of the samples using standards of known osmolality. The samples of interest were prepared, introduced within the instrument, and a corresponding osmolality value calculated from the determined freezing points of the solutions. The samples tested in Example 2 included sucrose solutions of various weight percentages, including a sample representative of the sucrose content that may be found in a full-calorie beverage mix, such as about 12° Bx, and a sucrose sample diluted from the level of a full-calorie beverage mix by abut 1:3 (about 4° Bx). The samples further included combinations of the 4° Bx sucrose sample and betaine as well as combinations of the 4° Bx sucrose and combinations of betaine and erythritol. Table 1 shows the combinations tested in this Example 2 and the results of three consecutive osmolality measurements.

TABLE 1

| | | | | | Observed Test Values | | | |
|---|---|---|---|---|---|---|---|---|
| | Composition (wt. %) | | | | (Osm/kg of water) | | | |
| Sam- | Su- | | | | Test | Test | Test | Aver- |
| ple | crose | Erythritol | Betaine | Water | 1 | 2 | 3 | age |
| 1 | 12 | 0 | 0 | 88 | 0.424 | 0.419 | 0.420 | 0.421 |
| 2 | 4 | 0 | 0 | 96 | 0.120 | 0.119 | 0.119 | 0.119 |
| 3 | 4 | 0 | 2.74 | 93.26 | 0.395 | 0.386 | 0.390 | 0.390 |
| 4 | 4 | 0.77 | 2.00 | 93.23 | 0.394 | 0.391 | 0.384 | 0.390 |
| 5 | 4 | 1.81 | 1.00 | 93.19 | 0.363 | 0.368 | 0.363 | 0.365 |
| 6 | 4 | 2.85 | 0 | 93.15 | 0.375 | 0.375 | 0.376 | 0.375 |

A given osmolality value in Example 2, as well as a given osmolality value in Example 3, may also be expressed as a freezing point depression by multiplication of the osmolality value by the constant 1.86 (° C.×kg of solvent/moles). The data in Example 2 illustrates that reducing the level of sugar in a partially-frozen mix from that found in a representative full-calorie mix by a level of about 1:3 results in a significant reduction in the molality or particle density of the solution. The reduction in particle density and corresponding change in freezing point may be offset by the providing of about 2.5 weight percent to about 3.0 weight percent betaine, such as illustrated by Sample 3. Alternatively, the solute density derived from reduction of sugar in a partially-frozen mix may be offset by the providing of a combination of erythritol and betaine, as shown in each of Sample 4, Sample 5, and Sample 6. The caloric content of Sample 3 (about 27 kilocalories) is reduced to a level that is about 55% that of the full-calorie sample (about 48 kilocalories). Other adjustments, such as further adjustment of the level of betaine included, may afford other caloric reduction, such as to any level greater than about 35% of the caloric-content of a typical full-calorie product.

Including a small amount of erythritol provides a greater caloric reduction than found for sample 3. For example, the caloric content of Samples 4 (about 24 kilocalories) is about one-half that of the full-calorie reference sample. The caloric content of sample 5 (about 20 kilocalories) is less than one-half (about 40%) that of the full-calorie reference sample. Sample 6 includes a slightly greater ratio of erythritol and includes a caloric content (about 17 kilocalories) that is about 35% that of the full-calorie reference sample.

### Example 3

In this Example 3, the osmolality of various solutions was determined using the procedure described above for Example 2. Standard solutions of different sugars, including high fructose corn syrup (HFCS 42) and sucrose, were prepared and measured. Standard solutions of both betaine and erythritol were separately prepared and tested. Sugars were analyzed over a range of weight percentages from about 5% to about 16%. Betaine and erythritol were tested over a range of weight percentages from about 0.1% to about 10%. Table 2 shows the combinations tested in this Example 3:

TABLE 2

| | Average measured value (moles/kg solvent) | | | |
|---|---|---|---|---|
| Weight (%) of selected | of selected ingredients | | | |
| ingredients | Sucrose | HFCS 42 | Erythritol | Betaine |
| 0.1 | | | | 5.67 × 10⁻³ |
| 0.5 | | | 0.037 | |
| 1 | | | 0.080 | 0.081 |
| 2 | | | 0.168 | 0.169 |
| 5 | 0.151 | 0.200 | 0.444 | 0.468 |
| 10 | 0.345 | 0.422 | 0.97 | 1.077 |
| 12 | 0.427 | 0.514 | | |
| 14 | 0.533 | 0.621 | | |
| 16 | 0.627 | 0.724 | | |

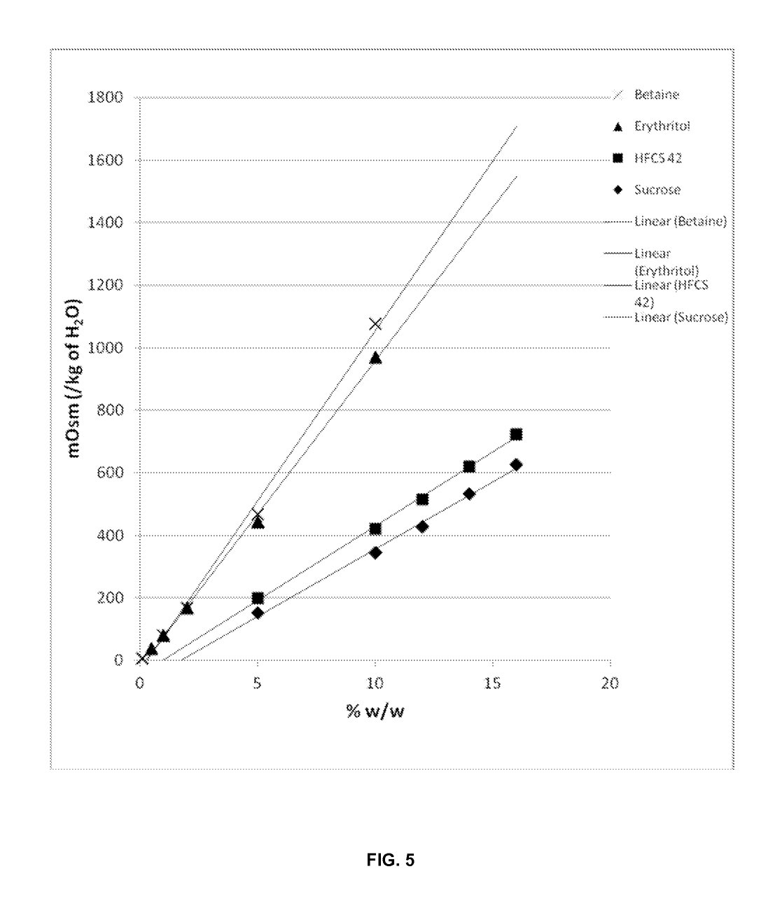

The data in Table 2 is also shown in FIG. 5. As shown in FIG. 5, addition of erythritol and betaine may be used to provide particle density in a partially-frozen beverage.

All patent documents identified herein are incorporated herein by reference.

While many examples in this document refer to partially-frozen, reduced-calorie beverages, mixes or syrups, or concentrates, it is understood that those compositions are described in an exemplary manner only and that other compositions may be used. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

I claim:

1. A beverage mix comprising:
about 0.1% to about 4% by weight betaine;
a natural-caloric sweetener; and
a high-intensity sweetener.

2. The beverage mix of claim 1 wherein said natural-caloric sweetener is in an amount of about 7° Bx to about 11° Bx; and
wherein said betaine is present at about 0.5% to about 2% by weight.

3. The beverage mix of claim 1 wherein said natural-caloric sweetener is in an amount of about 2° Bx to about 7° Bx; and
wherein said betaine is present at about 0.5% to about 4% by weight.

4. The beverage mix of claim 1 further comprising at least one sugar alcohol;
wherein said natural-caloric sweetener is in an amount of no more than 6 weight percent; and
wherein the total amount of said at least one sugar alcohol is no more than 2% by weight.

5. The beverage mix of claim 4 wherein the beverage mix contains less than 0.1 weight percent nutritive sweeteners.

6. The beverage mix of claim 4 wherein the beverage mix is substantially free of nutritive sweeteners.

7. The beverage mix of claim 1 further comprising a sugar alcohol at no more than about 0.20 moles of sugar alcohol per kilogram of water in the mix.

8. The beverage mix of claim 7 wherein said sugar alcohol is present at no more than about 0.17 moles of sugar alcohol per kilogram of water in the mix.

9. The beverage mix of claim 7 wherein said sugar alcohol is present at no more than about 0.10 moles of sugar alcohol per kilogram of water in the mix.

10. The beverage mix of claim 1 wherein the beverage mix is compatible with a conventional apparatus used for production of a partially-frozen beverage.

11. A beverage concentrate comprising:
betaine;
a natural-caloric sweetener; and
a high-intensity sweetener;
wherein the beverage concentrate is configured for dilution with a predetermined amount of water to provide a beverage mix configured for use in an apparatus for production of a partially-frozen beverage.

12. The beverage concentrate of claim 11 wherein said dilution comprises the combination of said concentrate and said water in a ratio of about 1:3 to about 1:6.

13. The beverage concentrate of claim 11 wherein the concentrate is a solid.

14. The beverage concentrate of claim 11 wherein the beverage mix includes betaine at a molal concentration of up to about 350 moles per kilogram of mix solvent.

15. A reduced-calorie, partially-frozen beverage comprising:
about 0.1% to about 4% by weight betaine;
a natural-caloric sweetener; and
a high-intensity sweetener.

16. The reduced-calorie, partially-frozen beverage of claim 15 wherein said betaine is between about 1.8% to about 2.5% by weight.

17. The reduced-calorie, partially-frozen beverage of claim 15 wherein said betaine is between about 1.4% to about 2.0% by weight.

18. The reduced-calorie, partially-frozen beverage of claim 15 further comprising carbon dioxide.

19. The reduced-calorie, partially-frozen beverage of claim 15 wherein the beverage provides less than 5.0 kilocalories per ounce upon consumption.

20. The reduced-calorie, partially-frozen beverage of claim 15 further comprising up to about 2.0% by weight sugar alcohols; and
wherein the beverage provides less than about 4.5 kilocalories per ounce upon consumption.
